(19) United States
(12) Patent Application Publication
(10) Pub. No.: US 2014/0118279 A1
(43) Pub. Date: May 1, 2014

(54) TOUCH DISPLAY SCREEN AND TOUCH DISPLAY APPARATUS

(71) Applicant: BEIJING BOE OPTOELECTRONICS TECHNOLOGY CO., LTD., Beijing (CN)

(72) Inventors: XIAOLIANG DING, Beijing (CN); XUE DONG, Beijing (CN); HAISHENG WANG, Beijing (CN); YINGMING LIU, Beijing (CN); SHENGJI YANG, Beijing (CN); TAO REN, Beijing (CN); WEIJIE ZHAO, Beijing (CN); HONGJUAN LIU, Beijing (CN)

(73) Assignee: BEIJING BOE OPTOELECTRONICS TECHNOLOGY CO., LTD., Beijing (CN)

(21) Appl. No.: 14/063,187

(22) Filed: Oct. 25, 2013

(30) Foreign Application Priority Data
Oct. 26, 2012 (CN) 201210418653.2

(51) Int. Cl. G06F 3/041

(52) U.S. Cl. CPC G06F 3/041
USPC 345/173

(57) ABSTRACT

A touch display screen and a touch display apparatus are disclosed. The touch display screen comprises: an array substrate and a color film substrate disposed box to box; a group of first electrode lines disposed on the array substrate or the color film substrate; a group of second electrode lines disposed on the array substrate or the color film substrate and arranged as crossing the group of first electrode lines; a conductive shielding layer with high-resistance transparency, disposed on the color film substrate and located above the group of first electrode lines and the group of second electrode lines. Because the resistance value of the conductive shielding layer with high resistance and transparency is high, a projected field signal between the first electrode lines and the second electrode lines may pass through the conductive shielding layer to ensure a realizability of touch operations.

### TECHNICAL FIELD

The present invention relates to a Held of touch display technique, and particularly to a touch display screen and a touch display apparatus.

### BACKGROUND

Currently, most of mutual capacitive touch screens are of out-cell type, that is, the touch screen and the display screen are manufactured separately and then attached together. This technique has disadvantages of a high manufacture cost, a low transmittance and a thick size of module. With developments of science and technology, an in-cell touch screen technique has become a new favorite of research and development gradually, and the in-cell touch screen technique refers to a technique capable of disposing driving electrode lines and exploring electrode lines for implementing the touch function on a substrate of the display screen. A touch display apparatus employing the in-cell touch screen technique is advantageous in that it is thinner and has a wider angle of view, a higher performance and a lower cost, as compared with the out-cell touch display apparatus.

Taking a specific application that the touch screen is embedded into a display screen of an ADS (Advanced Super Dimension Switch, referred to as ADS shortly) mode as an example, part of slit electrodes on an array substrate act as driving electrode lines for implementing the touch function, exploring electrode lines distributed crossing the driving electrode lines are disposed between a underlay substrate and a black array of a color film substrate, a driving circuit drives the slit electrodes in a time division manner, and the slit electrodes operate in different states in the time division manner. For example, the slit electrodes function as the slit electrodes and form a multi-dimensional electrical field together with plate electrodes during a first period of time, and function as the driving electrode lines and generate mutual inductance capacitances with the exploring electrode lines during a second period of time. p In order to avoid the display screen of an ADS mode is affected by electrostatic charges, a conductive shielding layer which is transparent and in a plane shape, is generally disposed between the underlay substrate and a polaroid of the color film substrate, such that the shielding layer may make the external electrostatic charges be grounded rapidly and avoid the electrostatic damage on the display screen caused by the electrostatic charges when electrostatic charges contact the display screen.

However, the shielding layer in a plane shape blocks a projected electrical field signal between the driving electrode lines and the exploring electrode lines to pass through while it grounds the electrostatic charges, which affects greatly an achievement of the touch effect.

### SUMMARY

The embodiments of the present invention provide a touch display screen and a touch display apparatus to settle problems that the projected field signal between the driving electrode lines and the exploring electrode lines in the existing touch display screen are blocked by the shielding layer in a plane shape, and that the touch effect is difficult to be achieved.

A touch display screen according to the embodiments of the present invention comprises:

an array substrate and a color film substrate disposed box to box;

a group of first electrode lines disposed on the array substrate or the color film substrate;

a group of second electrode lines disposed on the array substrate or the color film substrate and arranged as crossing the group of first electrode lines;

a conductive shielding layer with high-resistance and transparency, disposed on the color film substrate and located above the group of first electrode lines and the group of second electrode lines.

Optionally, the conductive shielding layer with high-resistance and transparency, is disposed between a color film substrate base and a polarizer of the color film substrate.

Optionally, the group of first electrode lines and the group of second electrode lines are disposed on the array substrate, and the conductive shielding layer, which has the high resistance and is transparent, is disposed inside of the color film substrate base of the color film substrate.

Exemplarily, the touch display screen further comprises a conductive sealant disposed between the array substrate and the color film substrate, and connected conductively with the conductive shielding layer with high-resistance and transparency.

Exemplarily, a resistance value of the conductive shielding layer with high-resistance and transparency is greater than 1Ω and smaller than 1000Ω.

Exemplarily, the conductive shielding layer with high-resistance and transparency comprises carbon nanotube particles and/or metal particles.

Optionally, the first electrode lines are driving electrode lines and the second electrode lines are exploring electrode lines, or the first electrode lines are the exploring electrode lines and the second electrode lines are the driving electrode lines.

A display apparatus according to the embodiments of the present invention comprises the touch display screen as stated in any of the solutions described above.

In the solutions according to the embodiments of the present invention, the resistance value of the conductive shielding layer with high-resistance and transparency is high to enable a projected field signal between the first electrode lines and the second electrode lines pass through the layer and a realization of touch operations may be ensured; further, the shielding layer is conductive itself, therefore the shielding layer may ground and lead out external electrostatic charges rapidly when the electrostatic charges contact with the display screen, which may avoid an electrostatic damage on the display screen caused by the electrostatic charges and further enhance a display effect. Therefore the solutions according to the embodiments of the present invention take both an electrostatic prevention characteristic and a touch function in a product into consider.

### BRIEF DESCRIPTION OF THE DRAWINGS

FIG. 1 is an exemplary view illustrating a cross structure of a touch display screen according to an embodiments of the present invention.

### REFERENCE SIGNS

10-array substrate

11-color film substrate

12-first electrode lines

13-second electrode lines

14-conductive shielding layer with the high resistance and transparency

15-conductive sealant

16-color film underlay substrate

### DETAILED DESCRIPTION

In order to settle the problems that the projected field signal between the driving electrode lines and the exploring electrode lines in the existing touch display screen are blocked by the shielding layer in a plane shape, and that the touch effect is difficult to be implemented, the embodiments of the present invention provide a touch display screen and a touch display apparatus. In the solutions according to the embodiments of the present invention, a conductive shielding layer with high-resistance and transparency, is disposed on a color film substrate and located above a group of first electrode lines and a group of second electrode lines. Because of the characteristic of high resistance of the conductive shielding layer, a projected field signal between the first electrode lines and the second electrode lines may pass through the conductive shielding layer to ensure the realizability of touch operations. Meanwhile, because of the characteristic of conductive of the shielding layer, an electrostatic damage on the display screen caused by the electrostatic charges can be avoided to further enhance a display effect. Below will describe the present invention in details by illustrating the embodiments in order to make the object, solutions, and advantages of the present invention be clearer.

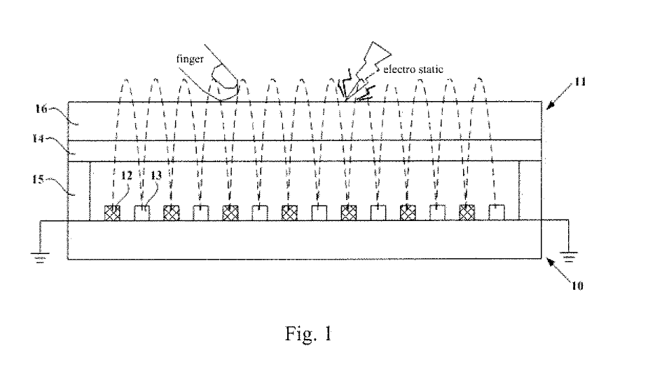

As illustrated in FIG. 1, a touch display screen according to the embodiments of the present invention comprises:

an array substrate 10 and a color film substrate 11 disposed box to box;

a group of first electrode lines 12 disposed on the array substrate 10 or the color film substrate 11;

a group of second electrode lines 13 disposed on the array substrate 10 or the color film substrate 11 and arranged crossing the group of first electrode lines 12;

a conductive shielding layer 14 with high-resistance and transparency, disposed on the color film substrate 11 and located above the group of first electrode lines 12 and the group of second electrode lines 13.

The first electrode lines 12 and the second electrode lines 13 may be disposed on either the array substrate 10 or the color film substrate 11, as long as they cross with each other and can form an electric field of mutual inductances. In FIG. 1, the first electrode lines 12 and the second electrode lines 13 are both disposed on the array substrate 11. The touch display screen further comprises a conductive sealant 15 disposed between the array substrate 10 and the color film substrate 11, and connected conductively with the conductive shielding layer 14 with high-resistance and transparency. The conductive shielding layer 14 with high-resistance and transparency is connected to a flexible board (not shown) through the conductive sealant 15 and is grounded in turn. As an electrostatic shielding unit, a function of the conductive shielding layer 14 with high-resistance and transparency is to lead electrostatic charges rapidly to the ground so as to avoid harmful influence on the screen display caused by the external electrostatic charges and prevent an electrostatic damage. It is necessary for materials of the conductive shielding layer with high-resistance and transparency to take account of requirements of high-resistance, transmittance and conductivity, and the conductive shielding layer with high-resistance and transparency comprises a resin layer, a silicon nitride layer or the like having carbon nanotube particles and/or metal particles. A resistance value of the conductive shielding layer with high-resistance and transparency is greater than 1Ω and smaller than 1000Ω.

The carbon nanotube is a kind of pipe formed by graphite atoms which twine coaxially in a single layer or by an interpenetration of single-layer graphite tubes coaxially layer by layer. A diameter of the nanotube is generally between one nanometer to dozens of nanometers, and its length is much greater than the diameter. As a one-dimensional nanophase material, the carbon nanotube has a light weight, a hexagonal structure connected perfectly and many other exceptional performances in mechanics, electricity and chemistry. With a deep research in the carbon nanotube and the nanophase material, their wider application prospects are continually emerging in recent years.

In the solutions according to the embodiments of the present invention, the resistance value of the conductive shielding layer with high-resistance and transparency, is high to enable a projected field signal between the first electrode lines and the second electrode lines to pass through the conductive shielding layer and ensure a realizability of touch operations. Further, the shielding layer itself is conductive, and thus the shielding layer may lead rapidly the external electrostatic charges to ground when the electrostatic charges contact with the display screen, which avoids an electrostatic damage on the display screen caused by the electrostatic charges and further enhance the display effect. Therefore, the solutions according to the embodiments of the present invention take both an electrostatic prevention characteristic and a touchable performance in a product into consider.

A position of the transparent and conductive shielding layer 14 on the color film substrate 11 is not limited, as long as it is located above the group of first electrode lines 12 and the group of second electrode lines 13. As such, the electrostatic charges are prevented from entering into the screen to damage related devices or influence the display effect. For example, the color film substrate 11 generally comprises a color film underlay substrate 16 and a polaroid (not shown) located above the color film underlay substrate, and the conductive shielding layer 14 with high-resistance and transparency may be disposed between the color film underlay substrate 16 and the polaroid. In another example, when the first electrode lines 12 and the second electrode lines 13 are both disposed on the array substrate 10, the conductive shielding layer 14 with high-resistance and transparency may be disposed inside the color film underlay substrate 16 of the color film substrate 11.

A touch display screen according to the embodiments of the present invention may have a plurality of display modes such as IPS (In-Plane Switching), ADS and so on. Taking the ADS mode as an example, an array substrate in this mode comprises plate electrodes and slit electrodes located above the plate electrodes and having a plurality of strip electrode units, wherein the group of first electrode lines or the group of second electrode lines is the strip electrode units arranged every other.

The ADS mode is a liquid crystal display mode capable of widening an angle of view. It forms a multi-dimensional electric field by means of an electric field generated at edges of the slit electrodes and an electric field generated between the slit electrode layer and the plate electrode layer in a same plane, which enables liquid crystal molecules in any directions between the slit electrodes or just above the electrodes in a liquid crystal box to generate a rotation, so that an operation efficiency of the liquid crystal is improved and the transmittance efficiency is increased. The ADS mode has advantages of a high resolution, a high transmittance, low power consumption, a wide angle of view, a high aperture ratio, a low color difference, no water ripples as squeezed, etc. Embedding the touch screen into the display screen with the ADS mode will be a principal trend of the touch display in the future.

As a part for implementing the touch function, the first electrode lines 12 may be driving electrode lines and the second electrode lines 13 may be exploring electrode lines, or the first electrode lines 12 may be the exploring electrode lines and the second electrode lines 13 may be the driving electrode lines.

A display apparatus according to the embodiments of the present invention comprises the touch display screen as stated in any embodiments as described above, and has a good electrostatic prevention characteristic and a good touchable performance.

The embodiments of the invention may be varied and modified by those skilled in the art in many ways without departing from the spirit and scope of the invention. All the variations and modifications belonging to the scope of the following claims and its equivalents are intended to be included within the scope of the following claims.

What is claimed is:

1. A touch display screen, comprising:
an array substrate and a color film substrate disposed box to box;
a group of first electrode lines disposed on the array substrate or the color film substrate;
a group of second electrode lines disposed on the array substrate or the color film substrate and arranged as crossing the group of first electrode lines; and
a conductive shielding layer with high-resistance and transparency, disposed on the color film substrate and located above the group of first electrode lines and the group of second electrode lines.

2. The touch display screen of claim 1, wherein the conductive shielding layer with high resistance and transparency is disposed between a color film underlay substrate and a polaroid of the color film substrate.

3. The touch display screen of claim 1, wherein the group of first electrode lines and the group of second electrode lines are disposed on the array substrate, and the conductive shielding layer with high-resistance and transparency is disposed inside of the color film underlay substrate of the color film substrate.

4. The touch display screen of claim 3, wherein the touch display screen further comprises a conductive seal agent disposed between the array substrate and the color film substrate, and connected conductively with the conductive shielding layer with high-resistance and transparency.

5. The touch display screen of claim 1, wherein a resistance value of the conductive shielding layer with high-resistance and transparency is greater than 1Ω and smaller than 1000Ω.

6. The touch display screen of claim 1, wherein the conductive shielding layer with high-resistance and transparency comprises carbon nanotube particles or metal particles.

7. The touch display screen of claim 1, wherein the first electrode lines are driving electrode lines and the second electrode lines are exploring electrode lines, or the first electrode lines are the exploring electrode lines and the second electrode lines are the driving electrode lines.

8. The touch display screen of claim 1, wherein the first electrode lines are the exploring electrode lines and the second electrode lines are the driving electrode lines.

9. A touch display apparatus comprising a touch display screen, wherein the touch display screen comprises:
an array substrate and a color film substrate disposed box to box;
a group of first electrode lines disposed on the array substrate or the color film substrate;
a group of second electrode lines disposed on the array substrate or the color film substrate and arranged as crossing the group of first electrode lines; and
a conductive shielding layer with high-resistance and transparency, disposed on the color film substrate and located above the group of first electrode lines and the group of second electrode lines.

10. The touch display apparatus of claim 9, wherein the conductive shielding layer with high resistance and transparency is disposed between a color film underlay substrate and a polaroid of the color film substrate.

11. The touch display apparatus of claim 9, wherein the group of first electrode lines and the group of second electrode lines are disposed on the array substrate, and the conductive shielding layer with high-resistance and transparency is disposed inside of the color film underlay substrate of the color film substrate.

12. The touch display apparatus of claim 11, wherein the touch display screen further comprises a conductive seal agent disposed between the array substrate and the color film substrate, and connected conductively with the conductive shielding layer with high-resistance and transparency.

13. The touch display apparatus of claim 9, wherein a resistance value of the conductive shielding layer with high-resistance and transparency is greater than 1Ω and smaller than 1000Ω.

14. The touch display apparatus of claim 9, wherein the conductive shielding layer with high-resistance and transparency comprises carbon nanotube particles or metal particles.

15. The touch display apparatus of claim 9, wherein the first electrode fines are driving electrode lines and the second electrode lines are exploring electrode lines, or the first electrode lines are the exploring electrode lines and the second electrode lines are the driving electrode lines.

16. The touch display apparatus of claim 9, wherein the first electrode lines are the exploring electrode lines and the second electrode lines are the driving electrode lines.
